(19) United States
(12) Patent Application Publication
(10) Pub. No.: US 2007/0180049 A1
(43) Pub. Date: Aug. 2, 2007

(54) Code hyperlinks

(75) Inventors: Andrei V. Chtcherbatchenko, Redmond, WA (US); Hessan Tchaitchian, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/343,390

(22) Filed: Jan. 31, 2006

(51) Int. Cl. G06F 15/16

(52) U.S. Cl. 709/217

(57) ABSTRACT

Systems and methods are disclosed for providing code hyperlinks. The disclosed systems and methods may include displaying a code hyperlink in a code view of a computer programming code. The code hyperlink may be associated with a first segment of the computer programming code displayed in the code view. Furthermore, the disclosed systems and methods may include receiving a user input associated with the displayed code hyperlink and activating the code hyperlink based upon the received user input associated with the displayed code hyperlink.

### BACKGROUND

Editing computer programming code in a text view is not always easy. In virtually any computer programming language there are syntax elements that may be related to each other, for example, either semantically or functionally. These elements, however, may be located in different parts of a document or in different documents. For example, a script function may be implemented in a “<script>” block in a document header, with multiple calls to that function scattered in the document's body. Furthermore, cascading style sheet (CSS) rules may be implemented in a linked stylesheet document and a class attribute that matches the CSS rule may occur anywhere in the document. FIG. 5 illustrates programming elements and their related to other elements. In other words, the examples shown in FIG. 5 have references separated from definitions. For example, FIG. 5 shows: i) a script function call 505 and its corresponding definition 510; a CSS element 515 and its corresponding CSS style definition 520; iii) an hypertext markup language (HTML) link element 525, referencing a bookmark, and an HTML anchor element 530 representing the bookmark itself; iv) an HTML link element 535, referencing another document, and the other document 540 itself; and v) a call-template element 545 and an actual template 550.

The aforementioned conventional strategy often causes problems for a code editor user because, in order to understand the code contained in the document, the user needs to constantly scroll back and forth through the document. In all of the above cases, to edit a relevant code or to get familiar with it, the user needs to jump frequently between the reference and the definition, that are located in different document parts. Typically users employ bookmarks and code editor search facilities to find and bookmark references and definitions. Another approach is to use two document views simultaneously. Either approach is inconvenient and can be confusing.

In view of the foregoing, there is a need for methods and systems for providing code hyperlinks. Furthermore, there is a need for providing code hyperlinks utilizing, for example, history to aid the user in navigation.

### SUMMARY

Systems and methods are disclosed for providing code hyperlinks. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one embodiment, a method for providing code hyperlinks comprises displaying a code hyperlink in a code view of a computer programming code. The code hyperlink may be associated with a first segment of the computer programming code displayed in the code view. In addition, the method may include receiving a user input associated with the displayed code hyperlink. Furthermore, the method may include activating the code hyperlink based upon the received user input associated with the displayed code hyperlink.

According to another embodiment, a system for providing code hyperlinks comprises a memory storage for maintaining a database and a processing unit coupled to the memory storage. The processing unit may be operative to display a code hyperlink in a code view of a computer programming code. The code hyperlink may be associated with a first segment of the computer programming code displayed in the code view. In addition, the processing unit may be operative to receive a user input associated with the displayed code hyperlink. Furthermore, the processing unit may be operative to activate the code hyperlink based upon the received user input associated with the displayed code hyperlink.

In accordance with yet another embodiment, a computer-readable medium which stores a set of instructions which when executed performs a method for providing code hyperlinks. The method may be executed by the set of instructions comprising displaying a code hyperlink in a code view of a computer programming code. The code hyperlink may be associated with a first segment of the computer programming code displayed in the code view. In addition, the set of instructions may include receiving a user input associated with the displayed code hyperlink. Furthermore, the set of instructions may include activating the code hyperlink based upon the received user input associated with the displayed code hyperlink.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary system including a computing device consistent with an embodiment of the present invention;

FIG. 2 is a flow chart of an exemplary method for providing code hyperlinks consistent with an embodiment of the present invention;

FIG. 3 illustrates a code view of a computer programming code including a code hyperlink consistent with an embodiment of the present invention;

FIG. 4 is a diagram showing a scenario for a user following a series of code hyperlinks consistent with an embodiment of the invention; and

FIG. 5 illustrates programming elements and their related other elements.

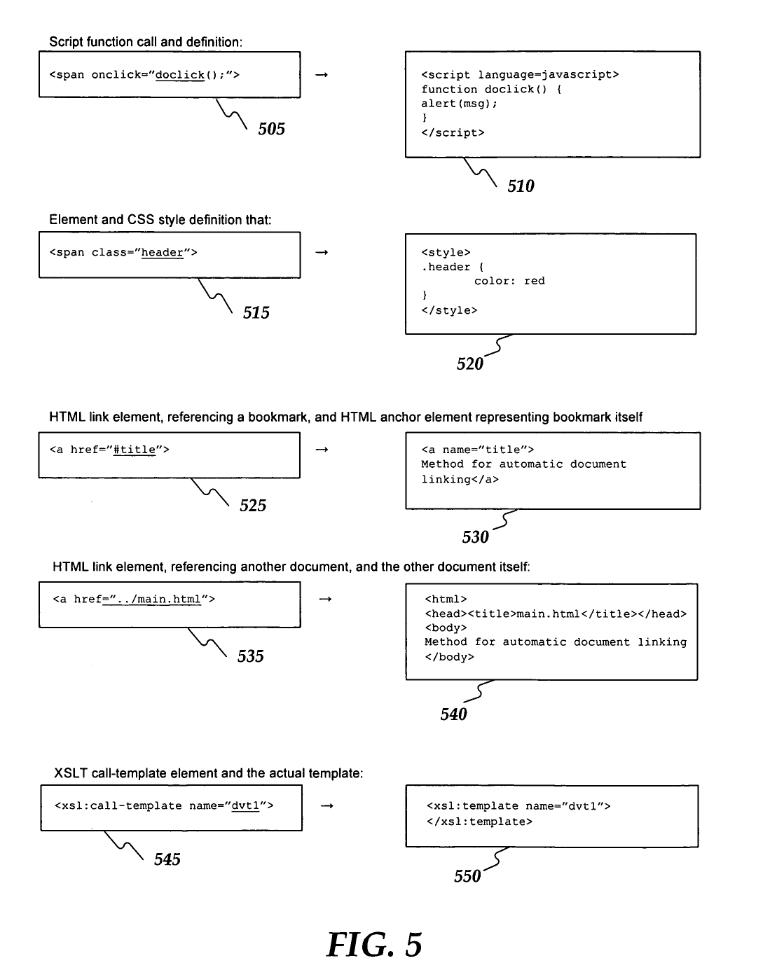

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

Systems and methods consistent with embodiments of the present invention provide code hyperlinks. A code hyperlink may comprise, for example, a user selectable element displayed by a code hyperlink application, which when selected, may cause the code editing application to navigate to an entity definition corresponding to the activated code hyperlink. Consistent with embodiments of the invention, the code hyperlink application may read a document containing code (e.g. a code file) and generate a code hyperlink based, for example, on language syntax embedded in a language in which the code is written. The generated hyperlink may be presented to a user in a code view within the code hyperlink application. Consequently, the generate hyperlink may be activated by input from the user to, for example, jump (or navigate) to an entity definition (e.g. a target location) corresponding to the activated hyperlink in the document or in another file. In addition, embodiments of the invention may include a history of documents and document locations that were used as sources and targets for hyperlink navigations. This history may be maintained in usable and consistent state when, for example, the document is edited or updated externally. Moreover, embodiments of the invention may include computing “previous” and “next” locations, when available, based on document modifications and user input, for example, that was made after an original hyperlink navigation.

Consistent with embodiments of the present invention, the code hyperlink application may comprise a code editor that may display both a WYSIWYG (what you see is what you get) view and a code view. The code hyperlink application may read a document or code file containing computer programming code. The computer programming code may be displayed in the code view. Certain elements in the code view may be displayed as code hyperlinks indicated, for example, as thin light blue underlines. For example, with CSS, the code hyperlink application may create a code hyperlink corresponding to a <span class=“header”> statement. The code hyperlink application may create code hyperlinks displayable in the code view by parsing the code file based on the computer programming code's language syntax rules contained in the code file. Any created hyperlink may be displayed to a user.

When the code hyperlink application detects that the user clicked on a displayed hyperlink, the code hyperlink application may perform a hyperlink navigation. In performing this navigation, the code hyperlink application may compute a target location for the clicked code hyperlink. This computation may depend, for example, on the hyperlink type (e.g. CSS class, script function, XSLT template, URL document, etc.) There may be a separate algorithm for each hyperlink type. For example, when a CSS class hyperlink is invoked in a <span class=“header”> statement, all <style> blocks and linked stylesheets may be scanned by the code hyperlink application looking for CSS rules that match the specific occurrence of the aforementioned <span> element. In other words, the code hyperlink application may scan the current code file that contains the aforementioned <span> element and it may scan other documents or code files that may be referenced, for example, by links in the current code file. From the resulting rules gathered by the scan, the code hyperlink application may select one that has the highest specificity. Furthermore, the code file that may contain the rule and the offset of the rule's selector in the document may be considered to be the hyperlink's target location.

Consistent with embodiments of the present invention the code hyperlink application may maintain a code hyperlink history to aid the user in navigation, providing, for example, a “jump back” command and a “jump forward” command. For example, once a code hyperlink is clicked, the user may be sent to a target location associated with a portion of the code file (or another linked code file) corresponding to the clicked hyperlink. After viewing the target, however, the user may not know how to get back to the position in the code from which the hyperlink was clicked. Consequently, the code hyperlink history may comprise a linked list of history records and a current position in that list. Each history record may contain a block of information that is sufficient to restore the code file (or the document) to the state in which it was before navigation to the target occurred. For example, for a code view it may be sufficient to have the uniform resource locator (URL) of the document, and the character offset in the document. The aforementioned code hyperlink history in not limited to a linked list of history records and may be implemented using, for example, an array or any other type data structure.

When hyperlink navigation is performed, for example, all history records after a current position may be discarded. Then a new history record may be created and attached to the current record. This new history record may be initialized with sufficient information to perform, for example, a jump back to the location of the hyperlink from which the hyperlink navigation originated. Then the current position may be set to a new history record.

Moreover, when a relevant user input or external event occurs (such as change of selection in the code editor, document (or code file) content modification, or external document modification), the history record that the current position points to may be updated in such a way that it reflects the user input and would still be sufficient to jump back to the location saved in that history record.

When a “jump back” command is invoked by the user, the current position may be changed to the previous history record, if any, then the information that may be saved in that record may be extracted and used to display a document location. Note that it does not necessarily mean the location of a hyperlink that caused the navigation because the information could have been updated while handling, for example, user input events that occurred after the navigation. Moving back and forward through the history, for example, may be described as switching between different editor states. Each state, for example, may not be static, but rather may be constantly updated when the document or the code file is in this state. Similarly, when a “jump forward” command is invoked, the current position may be advanced to the next history record, if any, and the information saved in that record may be extracted and used to display a document location, for example.

The code hyperlinks, for example, may be presented to the user as thin light blue underlines that can be activated by clicking on them while pressing the “Ctrl”. Furthermore, there may be separate key shortcuts to return back to the hyperlink that was last activated (e.g. “back” command) and to move forward to the target of current hyperlink if was previously activated (e.g. a “forward” command). A code hyperlink corresponding to a code file may be detected by parsing the code file, for example, after modifications to the code file. Hyperlink targets may be computed when a hyperlink is activated. For example, after jumping from “<span class=“style1”>” link in the code file to a “.style1.” class definition, a user may have deleted the span element along with text and all styles, including style1., for a design view of the code editing application. Then, for example, the user may press the “Alt+Left Arrow” keys to return back to a place in the code view where the “<span>” element was before it was deleted. Consistent with embodiments of the invention, the user can press the “Alt+Right Arrow” keys to go forward where the “.style1” definition was before it was deleted.

An embodiment consistent with the invention may comprise a system for providing code hyperlinks. The system may comprise a memory storage for maintaining a database and a processing unit coupled to the memory storage. The processing unit may be operative to display a code hyperlink in a code view of a computer programming code. The code hyperlink may be associated with a first segment of the computer programming code displayed in the code view. In addition, the processing unit may be operative receive a user input associated with the displayed code hyperlink and to activate the code hyperlink based upon the received user input associated with the displayed code hyperlink.

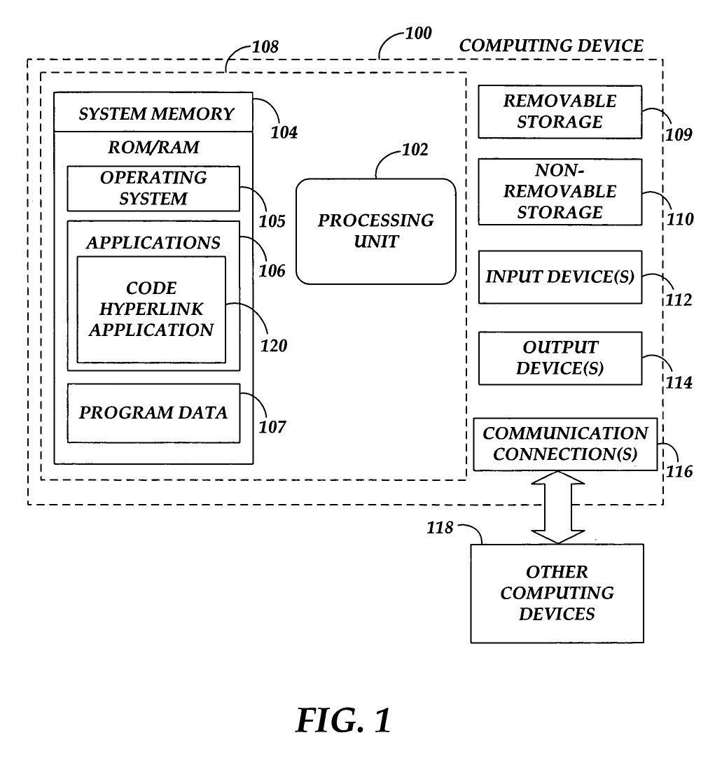

Consistent with an embodiment of the present invention, the aforementioned memory, processing unit, and other components may be implemented in a computing device, such as an exemplary computing device 100 of FIG. 1. Any suitable combination of hardware, software, and/or firmware may be used to implement the memory, processing unit, or other components. By way of example, the memory, processing unit, or other components may be implemented with any of computing device 100 or any of other computing devices 118, in combination with computing device 100. The aforementioned system, device, and processors are exemplary and other systems, devices, and processors may comprise the aforementioned memory, processing unit, or other components, consistent with embodiments of the present invention.

Generally, program modules may include routines, programs, components, data structures, and other types of structures that perform particular tasks or implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system consistent with an embodiment of the invention may include a computing device, such as computing device 100. In a basic configuration, computing device 100 may include at least one processing unit 102 and a system memory 104. Depending on the configuration and type of computing device, system memory 104 may be volatile (such as RAM), non-volatile (such as ROM, flash memory, etc.) or some combination. System memory 104 may include an operating system 105, one or more applications 106, and may include a program data 107. In one embodiment, applications 106 may include a code hyperlink application 120. However, embodiments of the invention may be practiced in conjunction with a graphics library, an operating system, or any application program and is not limited to any particular application or system. This basic configuration is illustrated in FIG. 1 by those components within a dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by a removable storage 109 and a non-removable storage 110. Computer storage media may include volatile and nonvolatile, removable and non-removable media implemented in any method or technology for storage of information, such as computer readable instructions, data structures, program modules, or other data. System memory 104, removable storage 109, and non-removable storage 110 are all examples of computer storage media. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. The aforementioned devices are exemplary and others may be used.

Computing device 100 may also contain a communication connection 116 that may allow device 100 to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein may include both storage media and communication media.

A number of program modules and data files may be stored in system memory 104 of computing device 100, including an operating system 105 suitable for controlling the operation of a networked personal computer, such as the WINDOWS operating systems from MICROSOFT CORPORATION of Redmond, Wash. System memory 104 may also store one or more program modules, such as code hyperlink application 120, and others described below. While executing on processing unit 102, code hyperlink application 120 may perform processes including, for example, one or more of the stages of the methods described below. The aforementioned process is exemplary, and processing unit 102 may perform other processes. Other applications 106 that may be used in accordance with embodiments of the present invention may include electronic mail and contacts applications, word processing applications, spreadsheet applications, database applications, slide presentation applications, drawing or computer-aided application programs, etc.

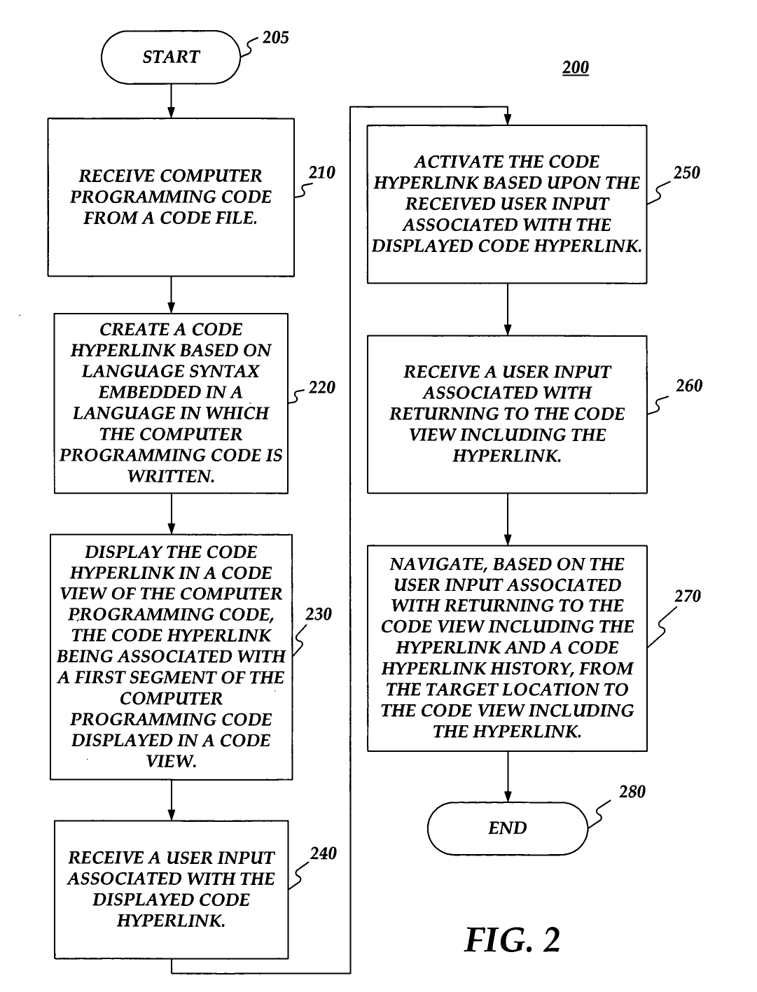

FIG. 2 is a flow chart setting forth the general stages involved in an exemplary method 200 consistent with the invention for providing code hyperlinks using system 100 of FIG. 1. Exemplary ways to implement the stages of exemplary method 200 will be described in greater detail below. Exemplary method 200 may begin at starting block 205 and proceed to stage 210 where computing device 100 may receive computer programming code from a code file. For example, the code file may be stored to system memory 104 from removable storage 109 or non-removable storage 110. The code file may include computer programming code written in any computer programming language.

From stage 210, where computing device 100 receives the computer programming code from the code file, exemplary method 200 may advance to stage 220 where computing device 100 may create a code hyperlink. For example, code hyperlink application 120 may comprise a code editor that may display both a WYSIWYG view and a code view of the read computer programming code. Executed on computing device 100, code hyperlink application 120 may parse the computer programming code and create the code hyperlink based, for example, on language syntax embedded in the language in which the computer programming code is written. For example, with CSS, code hyperlink application 120 may create the code hyperlink corresponding to a <span class=“header”> statement. Code hyperlink application 120 may create code hyperlinks displayable in the code view by parsing the computer programming code from the code file based on the computer programming code's language syntax rules. The created hyperlink may be displayed to a user, for example, on any of output devices 114.

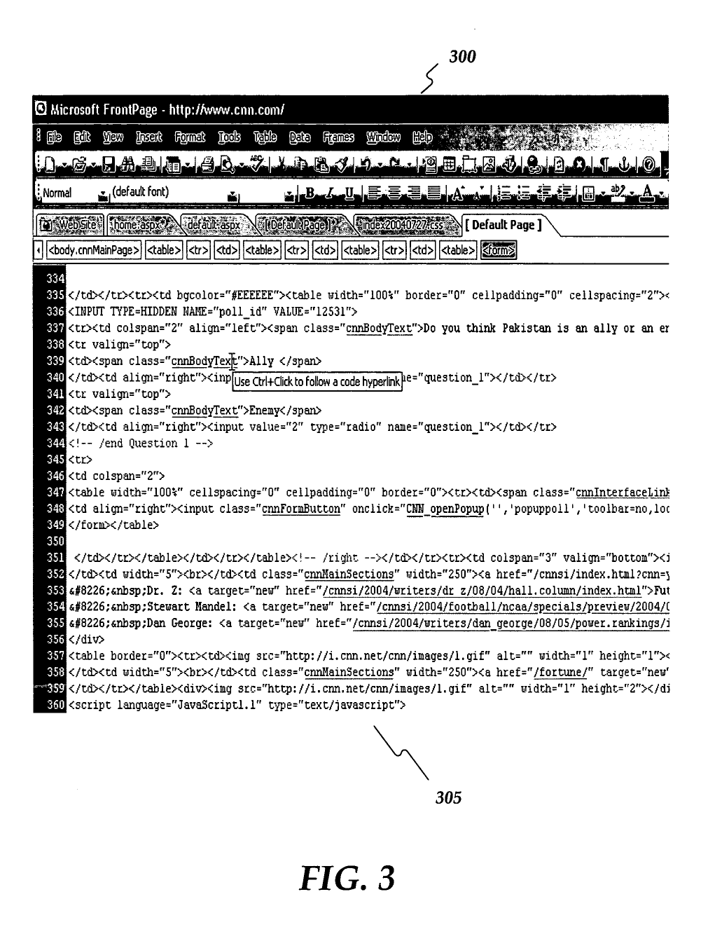

Once computing device 100 creates the code hyperlink in stage 220, exemplary method 200 may continue to stage 230 where computing device 100 may display the code hyperlink in a code view of the computer programming code. The code hyperlink may be associated with a first segment of the computer programming code displayed in the code view. For example, FIG. 3 illustrates a code view 300 of the computer programming code including a code hyperlink 305 consistent with an embodiment of the invention. As shown in FIG. 3, certain elements in code view 300 may be displayed as code hyper link 305 indicated, for example, with thin light blue underlines. Code hyperlink 305 may correspond to the first segment of the computer programming code displayed in code view 300.

After computing device 100 displays the code hyperlink in stage 230, exemplary method 200 may proceed to stage 240 where computing device 100 may receive a user input associated with the displayed code hyperlink. For example, using one of input devices 112, the user may click on code hyperlink 305 displayed in code view 300.

From stage 240, where computing device 100 receives the user input associated with the displayed code hyperlink, exemplary method 200 may advance to stage 250 where computing device 100 may activate the code hyperlink based upon the received user input associated with the displayed code hyperlink. For example, if the user clicks on code hyperlink 305 displayed in code view 300, code hyperlink application 120 may navigate the code view to a target location. In performing this navigation, code hyperlink application 120 may compute the target location for the clicked code hyperlink. This computation may depend, for example, on the hyperlink type (e.g. CSS class, script function, XSLT template, URL document, etc.) There may be a separate algorithm for each hyperlink type. For example, when a CSS class hyperlink is invoked in a <span class=“header”> statement, all <style> blocks and linked stylesheets may be scanned by code hyperlink application 120 looking for CSS rules that match the specific occurrence of the aforementioned <span> element. In other words, code hyperlink application 120 may scan the current code file that contains the aforementioned <span> element and it may scan other documents or code files that may be referenced, for example, by links in the current code file. From the resulting rules gathered by the scan, code hyperlink application 120 may select one that has the highest specificity. Furthermore, the code file that may contain the rule, and the offset of the rule's selector in the code file may be considered to be the hyperlink target location.

Once computing device 100 activates the code hyperlink in stage 250, exemplary method 200 may continue to stage 260 where computing device 100 may receive a user input associated with returning to the code view that included the hyperlink. For example, after code hyperlink application 120 navigates to the hyperlink target location, the user may have viewed the target location on one of output devices 114 and now wants to go back to the place from where the navigation began. To communicate this desire, the user may provide an input to code hyperlink application 120, through one of input devices 112, associated with returning to the code view that included hyperlink 305.

After computing device 100 receives the user input associated with returning to the code view that included the hyperlink in stage 260, exemplary method 200 may proceed to stage 270 where computing device 100 may navigate, based on the user input associated with returning to the code view that included hyperlink 305. Furthermore, computing device 100 may navigate based on a code hyperlink history. For example, the code hyperlink history may comprise a linked list of history records and a current position in that list wherein each history record contains a block of information that is sufficient to restore the computer programming code to a state in which the computer programming code was before navigation to the target occurred. Furthermore the code hyperlink history may be configured to be updated to reflect a user input configured to change the computer programming code. The code hyperlink history may still be sufficient to allow navigation from the target location to the code view including hyperlink 305 even though the code hyperlink history may be configured to be updated to reflect the user input configured to change the computer programming code. The target location may comprise a location in the computer programming code different from the first segment and a file different from a file containing the computer programming code. After computing device 100 navigates from the target location to the code view that included the hyperlink in stage 270, exemplary method 200 may then end at stage 280.

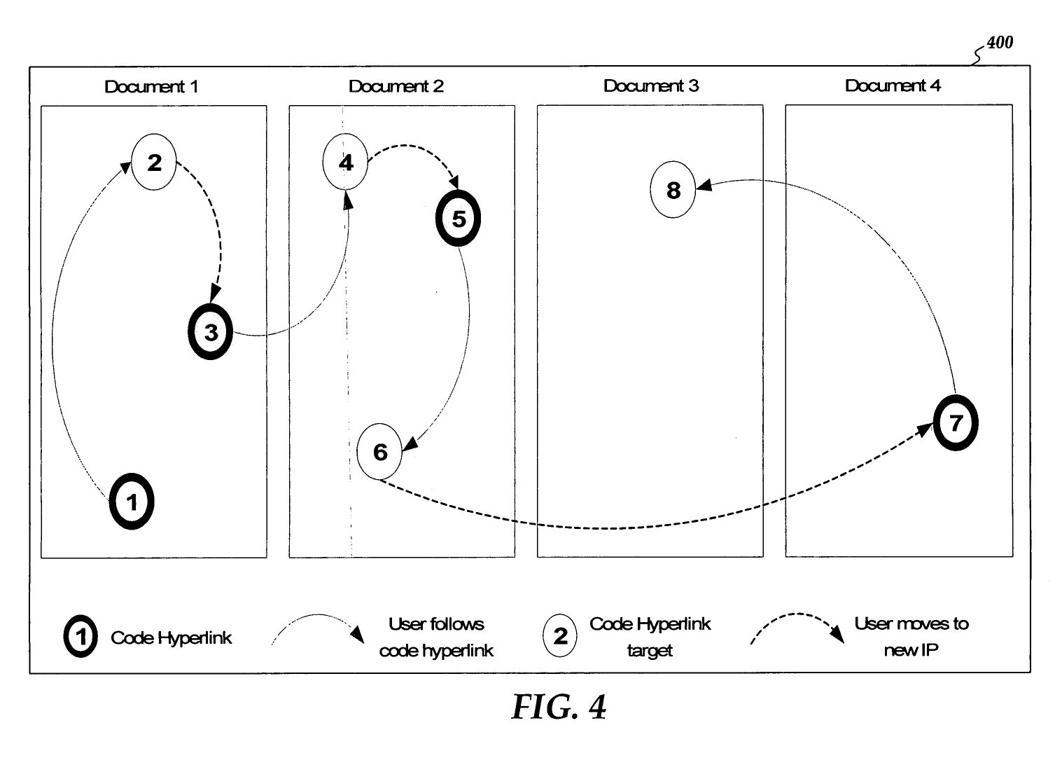

FIG. 4 is a diagram showing a scenario for a user following a series of code hyperlinks consistent with an embodiment of the invention. FIG. 4 shows, for example, how information may be stored in the code hyperlink history comprising a stack. For example, it is not uncommon for web developers to work on a section of a site in a code view, jump to a related area hundreds of lines away, and then try to find their way back to where they came. Embodiments of the invention may maintain a history of visited code hyperlinks that the user can navigate through, for example, with forward and back buttons. Users, for example, may access next and previous code hyperlink function through entry points comprising, for example, an edit menu, context menu, code view commandbar, and keyboard shortcuts.

When the user clicks on code hyperlink 305, for example, the hyperlink's location may be stored in a stack. The stack may then be navigated with a “next” and “previous” code hyperlink commands. Rules described below may define the logic used to maintain this stack as the user navigates code hyperlinks in different ways. When the user follows a code hyperlink, all elements above the current stack pointer may be removed, and the location of the current link may be added to the stack's top. The stack pointer may then be incremented. When the user goes back/forward to the previously visited code hyperlink, code hyperlink application 120 may decrement/increment the stack pointer and may jump to the code hyperlink stored in that location. This operation may be disabled if there are no entries beneath/above the current stack position.

If the user tries to go back (or forward) to a code hyperlink residing in a document that has been closed, for example, code hyperlink application 120 may re-open it and set an insertion point (IP) accordingly. The IP, for example, may comprise a point in a code editor where typed characters may be inserted.) If the file has been modified and the code hyperlink cannot be located, code hyperlink application 120 may, for example, go to the last known IP and invoke an invalid link target error with the following string: “cannot locate code hyperlink”. In this scenario, the invalid link pointer may be removed from the stack, so that if the user were to navigate back and then forward, the user would be skipped past the broken link. If the user tries to go back (or forward) to a code hyperlink that has since been deleted, code hyperlink application 120 may behave the same as the case above. The only difference may be that the document containing the link may already be open.

The stack may be cleared when a given window produced by code hyperlink application 120 is closed. For example, each window associated with code hyperlink application 120 may have its own stack. Frames may be opened as new page tabs and pages may be open only within a current window unless, for example, it is part of a subweb. A subweb, for example, may be a part of a web whose contents are stored in a subdirectory, to keep it apart from the rest of the web. This may be done for parts of the web that are unrelated in topic to the rest of the website, or technically different from the rest of the website, (e.g. a discussion web that may create many discussion-related files that should be kept together). Moreover, files that are moved or renamed may be fixed in the stack to continue working. Files that are deleted may be removed from the stack.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

What is claimed is:

1. A method for providing code hyperlinks, the method comprising:
displaying a code hyperlink in a code view of a computer programming code, the code hyperlink being associated with a first segment of the computer programming code displayed in the code view;
receiving a user input associated with the displayed code hyperlink; and
activating the code hyperlink based upon the received user input associated with the displayed code hyperlink.

2. The method of claim 1, further comprising:
receiving the computer programming code from a code file; and
creating the code hyperlink based on language syntax embedded in a language in which the computer programming code is written.

3. The method of claim 1, wherein activating the code hyperlink based upon the received user input comprises activating the code hyperlink based upon the received user input wherein the code view is navigated to a target location.

4. The method of claim 2, further comprising:
receiving a user input associated with returning to the code view including the hyperlink; and
navigating, based on the user input associated with returning to the code view including the hyperlink and a code hyperlink history, from the target location to the code view that included the hyperlink.

5. The method of claim 4, wherein navigating, based on the code hyperlink history comprises navigating based on the code hyperlink history comprising a linked list of history records and a current position in that list wherein each history record contains a block of information that is sufficient to restore the computer programming code to a state in which the computer programming code was before navigation to the target occurred.

6. The method of claim 4, wherein navigating, based on the code hyperlink history comprises navigating based on the code hyperlink history wherein the code hyperlink history is configured to be updated to reflect a user input configured to change the computer programming code wherein the code hyperlink history would still be sufficient to allow navigation from the target location to the code view including the hyperlink even though the code hyperlink history is configured to be updated to reflect the user input configured to change the computer programming code.

7. The method of claim 1, wherein activating the code hyperlink based upon the received user input comprises activating the code hyperlink based upon the received user input wherein the code view is navigated to a target location comprising one of the following: a location in the computer programming code different from the first segment and a file different from a file containing the computer programming code.

8. A system for providing code hyperlinks, the system comprising:
a memory storage for maintaining a database; and
a processing unit coupled to the memory storage, wherein the processing unit is operative to:
display a code hyperlink in a code view of a computer programming code, the code hyperlink being associated with a first segment of the computer programming code displayed in the code view;
receive a user input associated with the displayed code hyperlink; and
activate the code hyperlink based upon the received user input associated with the displayed code hyperlink.

9. The system of claim 1, further comprising the processing unit operative to:
receive the computer programming code from a code file; and
create the code hyperlink based on language syntax embedded in a language in which the computer programming code is written.

10. The system of claim 1, wherein the processing unit operative to activate the code hyperlink based upon the received user input comprises the processing unit operative to activate the code hyperlink based upon the received user input wherein the code view is navigated to a target location.

11. The system of claim 10, further comprising the processing unit operative to:
receive a user input associated with returning to the code view including the hyperlink; and
navigate, based on the user input associated with returning to the code view including the hyperlink and a code hyperlink history, from the target location to the code view that included the hyperlink.

12. The system of claim 11, wherein the processing unit operative to navigate, based on the code hyperlink history comprises the processing unit operative to navigate based on the code hyperlink history comprising a linked list of history records and a current position in that list wherein each history record contains a block of information that is sufficient to restore the computer programming code to a state in which the computer programming code was before navigation to the target occurred.

13. The system of claim 11, wherein the processing unit operative to navigate, based on the code hyperlink history comprises the processing unit operative to navigate based on the code hyperlink history wherein the code hyperlink history is configured to be updated to reflect a user input configured to change the computer programming code wherein the code hyperlink history would still be sufficient to allow navigation from the target location to the code view including the hyperlink even though the code hyperlink history is configured to be updated to reflect the user input configured to change the computer programming code.

14. A computer-readable medium which stores a set of instructions which when executed performs a method for providing code hyperlinks, the method executed by the set of instructions comprising:
displaying a code hyperlink in a code view of a computer programming code, the code hyperlink being associated with a first segment of the computer programming code displayed in the code view;
receiving a user input associated with the displayed code hyperlink; and
activating the code hyperlink based upon the received user input associated with the displayed code hyperlink.

15. The computer-readable medium of claim 14, further comprising:
receiving the computer programming code from a code file; and
creating the code hyperlink based on language syntax embedded in a language in which the computer programming code is written.

16. The computer-readable medium of claim 14, wherein activating the code hyperlink based upon the received user input comprises activating the code hyperlink based upon the received user input wherein the code view is navigated to a target location.

17. The computer-readable medium of claim 16, further comprising:
receiving a user input associated with returning to the code view including the hyperlink; and
navigating, based on the user input associated with returning to the code view including the hyperlink and a code hyperlink history, from the target location to the code view that included the hyperlink.

18. The computer-readable medium of claim 17, wherein navigating, based on the code hyperlink history comprises navigating based on the code hyperlink history comprising a linked list of history records and a current position in that list wherein each history record contains a block of information that is sufficient to restore the computer programming code to a state in which the computer programming code was before navigation to the target occurred.

19. The computer-readable medium of claim 17, wherein navigating, based on the code hyperlink history comprises navigating based on the code hyperlink history wherein the code hyperlink history is configured to be updated to reflect a user input configured to change the computer programming code wherein the code hyperlink history would still be sufficient to allow navigation from the target location to the code view including the hyperlink even though the code hyperlink history is configured to be updated to reflect the user input configured to change the computer programming code.

20. The computer-readable medium of claim 1, wherein activating the code hyperlink based upon the received user input comprises activating the code hyperlink based upon the received user input wherein the code view is navigated to a target location comprising one of the following: a location in the computer programming code different from the first segment and a file different from a file containing the computer programming code.
